(19) United States
(12) Patent Application Publication
(10) Pub. No.: US 2023/0065229 A1
(43) Pub. Date: Mar. 2, 2023

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Yutaka OISHI, Tokyo (JP); Michitaka KONDO, Tokyo (JP); Misaki OTSUKA, Tokyo (JP); Yuko MASUDA, Tokyo (JP)

(21) Appl. No.: 17/815,946

(22) Filed: Jul. 29, 2022

(30) Foreign Application Priority Data
Aug. 26, 2021 (JP) 2021-138396

(51) Int. Cl. G06F 3/06

(52) U.S. Cl. CPC G06F 3/0647; G06F 3/0686; G06F 3/0604

(57) ABSTRACT

An information processing apparatus performs, in a case where the same data is recorded in each of a plurality of storage pools each of which includes a plurality of generations of magnetic tapes and each for which a priority representing a degree to which a relatively-new-generation magnetic tape is used with priority is set, control of recording data recorded in a relatively-old-generation magnetic tape of a storage pool of which the priority is relatively high, in a relatively-old-generation magnetic tape of a storage pool of which the priority is relatively low.

### CROSS-REFERENCE TO RELATED APPLICATIONS

The present application claims priority under 35 U.S.C. § 119 to Japanese Patent Application No. 2021-138396 filed on Aug. 26, 2021. The above application is hereby expressly incorporated by reference, in its entirety, into the present application.

### BACKGROUND

### 1. Technical Field

The present disclosure relates to an information processing apparatus, an information processing method, and an information processing program.

### 2. Description of the Related Art

JP2008-250667A discloses a technique of configuring a storage pool with a plurality of magnetic tapes.

### SUMMARY

It is considered to multiplex and store data by recording the same data in a plurality of storage pools each of which includes a plurality of magnetic tapes. In addition, a plurality of generations of magnetic tapes may coexist in the plurality of magnetic tapes included in the storage pool. Further, in a storage system using magnetic tapes, for the purpose of storing data for a long term, increasing a capacity per magnetic tape, and improving a transmission speed, processing of migrating data recorded in an old-generation magnetic tape to a new-generation magnetic tape (hereinafter, referred to as “inter-generation migration processing) is performed.

In the inter-generation migration processing, since a data-migration-source magnetic tape is an old-generation magnetic tape, there is room for improvement from a viewpoint of shortening a time required for data migration. The technique described in JP2008-250667A does not consider a time required for data migration.

An object of the present disclosure is to provide an information processing apparatus, an information processing method, and an information processing program capable of shortening a time required for data migration.

According to an aspect of the present disclosure, there is provided an information processing apparatus including: at least one processor, in which the processor is configured to perform, in a case where the same data is recorded in each of a plurality of storage pools each of which includes a plurality of generations of magnetic tapes and each for which a priority representing a degree to which a relatively-new-generation magnetic tape is used with priority is set, control of recording data recorded in a relatively-old-generation magnetic tape of a storage pool of which the priority is relatively high, in a relatively-old-generation magnetic tape of a storage pool of which the priority is relatively low.

In the information processing apparatus according to the aspect of the present disclosure, the processor may be configured to perform, in a case of performing control of recording data in the storage pool in descending order of the priority and in a case where data is recorded in a relatively-new-generation magnetic tape of the storage pool of which the priority is relatively high, control of recording data in the storage pool of which the priority is relatively low without designating a magnetic tape as a data recording destination, and perform, in a case where data is recorded in a relatively-old-generation magnetic tape of the storage pool of which the priority is relatively high, control of designating a relatively-old-generation magnetic tape of the storage pool of which the priority is relatively low and recording data in the designated relatively-old-generation magnetic tape of the storage pool of which the priority is relatively low.

Further, in the information processing apparatus according to the aspect of the present disclosure, the priority may be higher as the number of relatively-new-generation magnetic tapes included in the storage pool is larger or as a total value of free capacities of relatively-new-generation magnetic tapes included in the storage pool is larger.

Further, in the information processing apparatus according to the aspect of the present disclosure, the processor may be configured to migrate data in order from the storage pool of which the priority is relatively low in a case of migrating data recorded in a relatively-old-generation magnetic tape to a relatively-new-generation magnetic tape in each of the plurality of storage pools, and use data read from a relatively-old-generation magnetic tape of the storage pool of which the priority is relatively low, for data migration in the storage pool of which the priority is relatively high.

Further, according to another aspect of the present disclosure, there is provided an information processing method executed by a processor of an information processing apparatus, the method including: performing, in a case where the same data is recorded in each of a plurality of storage pools each of which includes a plurality of generations of magnetic tapes and each for which a priority representing a degree to which a relatively-new-generation magnetic tape is used with priority is set, control of recording data recorded in a relatively-old-generation magnetic tape of a storage pool of which the priority is relatively high, in a relatively-old-generation magnetic tape of a storage pool of which the priority is relatively low.

Further, according to still another aspect of the present disclosure, there is provided an information processing program for causing a processor of an information processing apparatus to execute a process including: performing, in a case where the same data is recorded in each of a plurality of storage pools each of which includes a plurality of generations of magnetic tapes and each for which a priority representing a degree to which a relatively-new-generation magnetic tape is used with priority is set, control of recording data recorded in a relatively-old-generation magnetic tape of a storage pool of which the priority is relatively high, in a relatively-old-generation magnetic tape of a storage pool of which the priority is relatively low.

According to the present disclosure, it is possible to shorten a time required for data migration.

### BRIEF DESCRIPTION OF THE DRAWINGS

FIG. 1 is a block diagram illustrating an example of a configuration of an information processing system.

FIG. 2 is a block diagram illustrating an example of a hardware configuration of an information processing apparatus.

FIG. 3 is a diagram illustrating an example of a tape management table.

FIG. 4 is a diagram for explaining a storage pool.

FIG. 5 is a diagram for explaining priorities.

FIG. 6 is a block diagram illustrating an example of a functional configuration of the information processing apparatus.

FIG. 7 is a diagram for explaining data recording processing.

FIG. 8 is a diagram for explaining data recording processing.

FIG. 9 is a diagram illustrating an example of a data recording state.

FIG. 10 is a diagram for explaining data migration processing.

FIG. 11 is a flowchart illustrating an example of data recording processing.

FIG. 12 is a flowchart illustrating an example of data migration processing.

### DETAILED DESCRIPTION

Hereinafter, an example of an embodiment for performing a technique according to the present disclosure will be described in detail with reference to the drawings.

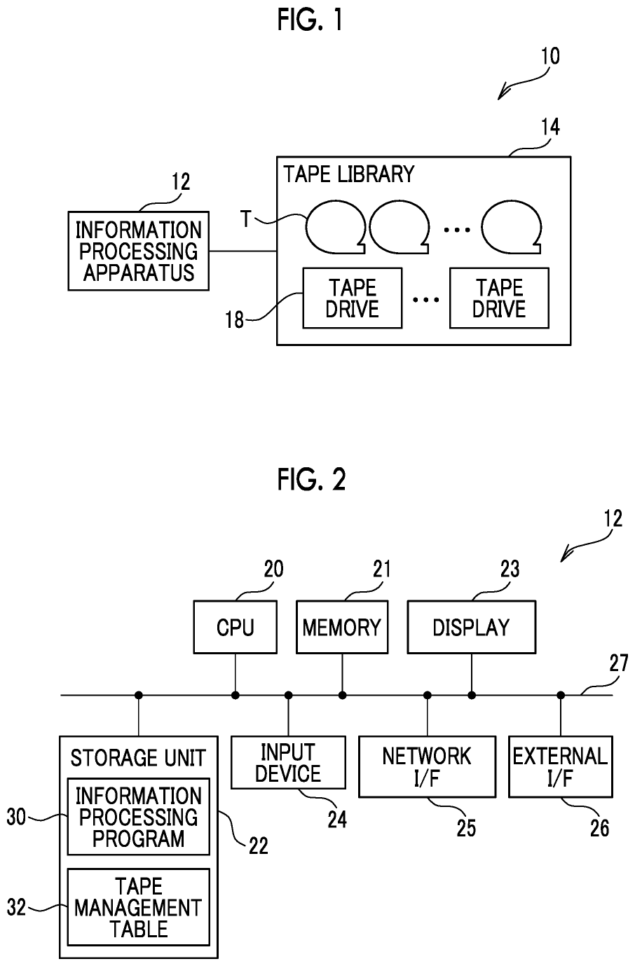

First, a configuration of an information processing system 10 according to the present embodiment will be described with reference to FIG. 1. As illustrated in FIG. 1, the information processing system 10 includes an information processing apparatus 12 and a tape library 14. Examples of the information processing apparatus 12 include a server computer and the like.

The tape library 14 includes a plurality of slots (not illustrated) and a plurality of tape drives 18, and each slot includes a magnetic tape T as an example of a recording medium. Each tape drive 18 is connected to the information processing apparatus 12. The tape drive 18 writes or reads data to or from the magnetic tape T under a control of the information processing apparatus 12. Examples of the magnetic tape T include a linear tape-open (LTO) tape.

In a case where the information processing apparatus 12 writes or reads data to or from the magnetic tape T, the magnetic tape T as a write target or a read target is loaded from the slot into a predetermined tape drive 18. In a case where data is written or read to and from the magnetic tape T loaded into the tape drive 18, the magnetic tape T is unloaded from the tape drive 18 into the slot in which the magnetic tape T is originally included.

Next, a hardware configuration of the information processing apparatus 12 according to the present embodiment will be described with reference to FIG. 2. As illustrated in FIG. 2, the information processing apparatus 12 includes a central processing unit (CPU) 20, a memory 21 as a temporary memory area, and a non-volatile storage unit 22. Further, the information processing apparatus 12 includes a display 23 such as a liquid crystal display, an input device 24 such as a keyboard and a mouse, a network interface (I/F) 25 connected to a network, and an external I/F 26 to which each tape drive 18 is connected. The CPU 20, the memory 21, the storage unit 22, the display 23, the input device 24, the network I/F 25, and the external I/F 26 are connected to a bus 27.

The storage unit 22 is realized by a hard disk drive (HDD), a solid state drive (SSD), a flash memory, or the like. An information processing program 30 is stored in the storage unit 22 as a storage medium. The CPU 20 reads the information processing program 30 from the storage unit 22, develops the read information processing program 30 in the memory 21, and executes the developed information processing program 30.

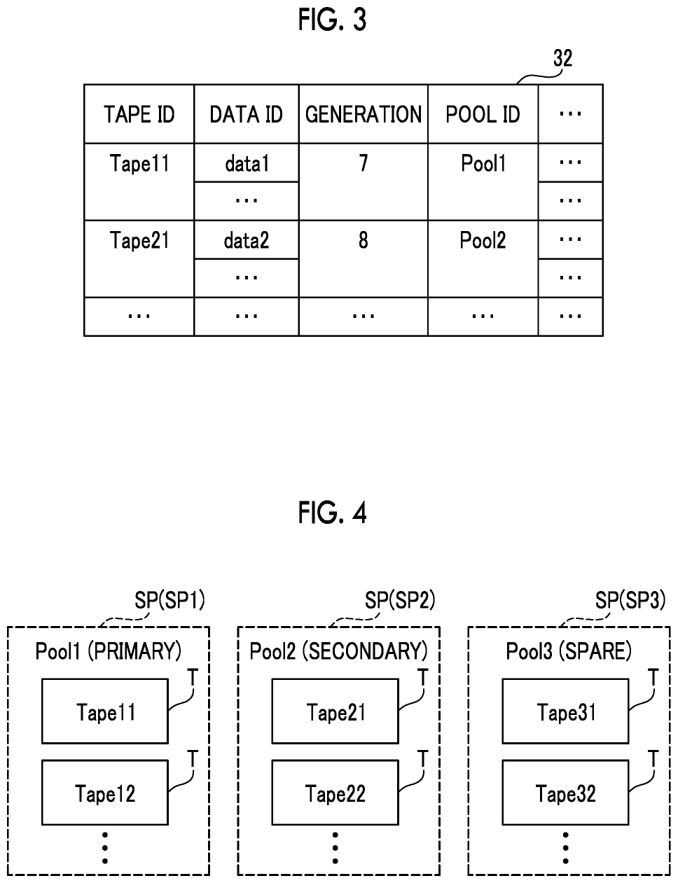

Further, the storage unit 22 stores a tape management table 32 for managing the magnetic tape T. FIG. 3 illustrates an example of the tape management table 32. As illustrated in FIG. 3, the tape management table 32 includes a tape identifier (ID) which is an example of identification information of the magnetic tape T and a data ID which is an example of identification information of the data recorded in the magnetic tape T.

Further, the tape management table 32 also includes information representing a generation of a standard of the magnetic tape T and a pool ID as an example of identification information of a storage pool to which the magnetic tape T belongs. The generation of the standard of the magnetic tape T is, for example, LTO7, LTO8, or the like. In the following, the generation of the standard of the magnetic tape T is simply referred to as a “generation”. In the tape library 14, a plurality of generations (two generations in the present embodiment) of magnetic tapes Ts are included. In the following, in the two generations, a relatively-old generation is referred to as an “old generation”, and a relatively-new generation is referred to as a “new generation”.

The tape library 14 according to the present embodiment includes a plurality of generations (two generations in the present embodiment) of the tape drives 18 in accordance with the generations of the magnetic tapes Ts. The old-generation tape drive 18 can read and write data only from and to the old-generation magnetic tape T among the two generations of magnetic tapes Ts. The new-generation tape drive 18 can read and write data from and to each of the two generations of magnetic tapes Ts.

Further, in the information processing system 10 according to the present embodiment, data is recorded with redundancy. Specifically, as an example, as illustrated in FIG. 4, a plurality of storage pool SPs, each including a plurality of magnetic tapes Ts, are prepared. A first storage pool SP is a storage pool SP for primary data, and a second storage pool SP is a storage pool SP for secondary data. A third storage pool SP is a storage pool SP for spare data. In the following, in a case of distinguishing three storage pools SPs, a storage pool SP for primary data is referred to as a storage pool SP1, a storage pool SP for secondary data is referred to as a storage pool SP2, and a storage pool SP for spare data is referred to as a storage pool SP3.

The same data is multiplexed and recorded in the three storage pools SPs. That is, a multiplicity is 3. The multiplicity is not limited to 3, may be 2, and may be 4 or more. Further, each of the three storage pools SPs includes a plurality of generations of magnetic tapes Ts. Normally, data is read from the magnetic tape T included in the storage pool SP1. In a case where data cannot be read from the storage pool SP1, data is read from the magnetic tape T included in the storage pool SP2. In a case where data cannot be read from both the storage pool SP1 and the storage pool SP2, data is read from the magnetic tape T included in the storage pool SP3.

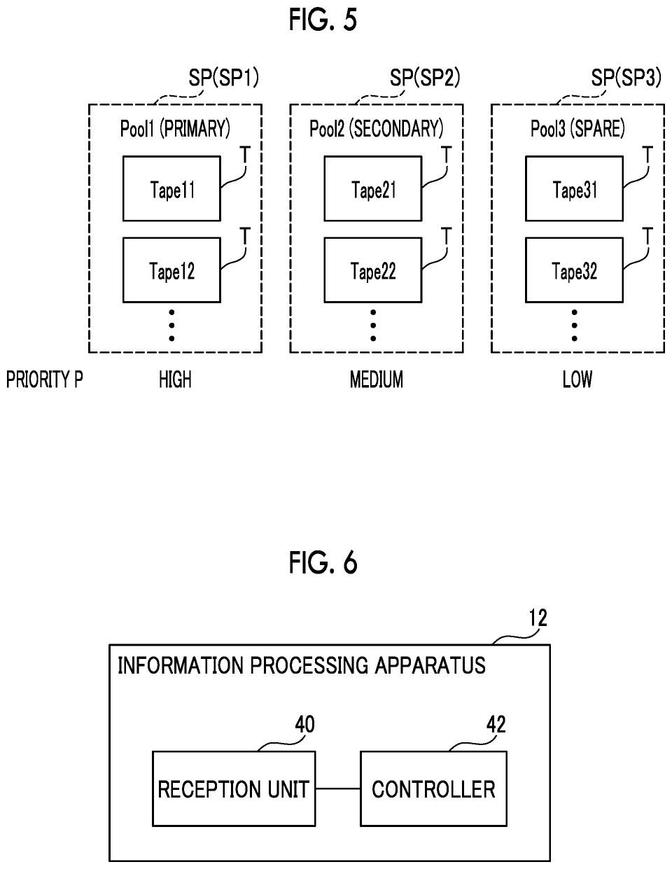

As an example, as illustrated in FIG. 5, a priority P indicating a degree to which a new-generation magnetic tape is used with priority is set in each of the plurality of storage pools SPs. The priority P is set in each storage pool SP, for example, by being input by a user via the input device 24. In the present embodiment, the priority P is set to three levels, and the priority of the first storage pool SP1 is set to a highest level “high”. Further, the priority of the second storage pool SP2 is set to a second highest level “medium”. Further, the priority of the third storage pool SP3 is set to a lowest level “low”. The priority P is not limited to three levels, and may be set, for example, to two levels.

In a case where the information processing apparatus 12 performs control of recording data in the storage pool SP, the information processing apparatus 12 may perform control of recording data in the storage pool SP without designating the magnetic tape T as a data recording destination. For example, in a case where the control is performed, the magnetic tapes Ts in the storage pool SP are used as a data recording destination in a predetermined order by a software program that manages the storage pools SPs. In this case, for example, the magnetic tapes Ts are used in order from the magnetic tape T having a largest free capacity. Further, for example, the magnetic tapes Ts may be used in order from the magnetic tape T having a smallest number at the end of the tape ID, and may be used in order from the magnetic tape T having a low use frequency.

Next, a functional configuration of the information processing apparatus 12 in a case of recording data in the storage pool SP configured as described above and in a case of migrating data recorded in the storage pool SP will be described with reference to FIG. 6. As illustrated in FIG. 6, the information processing apparatus 12 includes a reception unit 40 and a controller 42. In a case where the CPU 20 executes the information processing program 30, the information processing apparatus 12 functions as the reception unit 40 and the controller 42.

The reception unit 40 receives data to be recorded, the data being transmitted from a user terminal (not illustrated). Further, the reception unit 40 receives a data migration instruction. The data migration instruction may be transmitted from the user terminal or may be input via the input device 24.

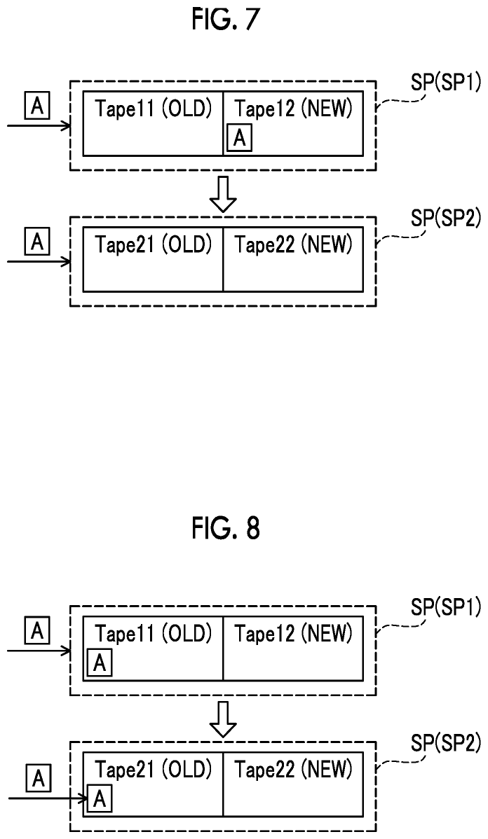

The controller 42 performs control of recording data to be recorded in each of the three storage pools SPs, the data being received by the reception unit 40. In the control, the controller 42 performs control of recording data, which is recorded in an old-generation magnetic tape T of the storage pool SP of which the priority P is relatively high, in an old-generation magnetic tape T of the storage pool SP of which the priority P is relatively low. Specific examples of the control will be described with reference to FIG. 7 to FIG. 9. In FIG. 7 to FIG. 9, a magnetic tape T described as “old” in parentheses represents an old-generation magnetic tape T, and a magnetic tape T described as “new” in parentheses represents a new-generation magnetic tape T.

The controller 42 performs control of recording data in the storage pool SP in order of higher priority P. In a case where the priority P which is set for the storage pool SP is the example illustrated in FIG. 5, as an example, as illustrated in FIG. 7 and FIG. 8, the controller 42 performs control of recording data in the storage pool SP1 of which the priority P is highest without designating a magnetic tape T as a data recording destination. By the control, data is recorded in any one of an old-generation magnetic tape T and a new-generation magnetic tape T of the storage pool SP1 by the software program that manages the storage pools SPs.

As illustrated in FIG. 7, in a case where data is recorded in the new-generation magnetic tape T of the storage pool SP1, the controller 42 performs control of recording data in the storage pool SP2 of which the priority P is lower than the priority of the storage pool SP1 without designating a magnetic tape T as a data recording destination. By the control, data is recorded in any one of an old-generation magnetic tape T and a new-generation magnetic tape T of the storage pool SP2 by the software program that manages the storage pools SPs.

On the other hand, as illustrated in FIG. 8, in a case where data is recorded in the old-generation magnetic tape T of the storage pool SP1, the controller 42 performs control of designating an old-generation magnetic tape T of the storage pool SP2 of which the priority P is lower than the priority of the storage pool SP1 and recording data in the designated old-generation magnetic tape T of the storage pool SP2. Thereby, data is recorded in the old-generation magnetic tape T of the storage pool SP2.

Similarly, in the storage pool SP3, control is switched depending on whether data is recorded in the new-generation magnetic tape T or the old-generation magnetic tape T of the storage pool SP2.

By the above control, data recorded in the old-generation magnetic tape T of the storage pool SP of which the priority P is relatively high is recorded in the old-generation magnetic tape T of the storage pool SP of which the priority P is lower than the priority of the storage pool SP. On the other hand, data recorded in the new-generation magnetic tape T of the storage pool SP of which the priority P is relatively high is recorded in any one of the old-generation magnetic tape T and the new-generation magnetic tape T of the storage pool SP of which the priority P is lower than the priority of the storage pool SP. In this case, whether data is recorded in the old-generation magnetic tape T or the new-generation magnetic tape T is determined by the software program that manages the storage pools SPs.

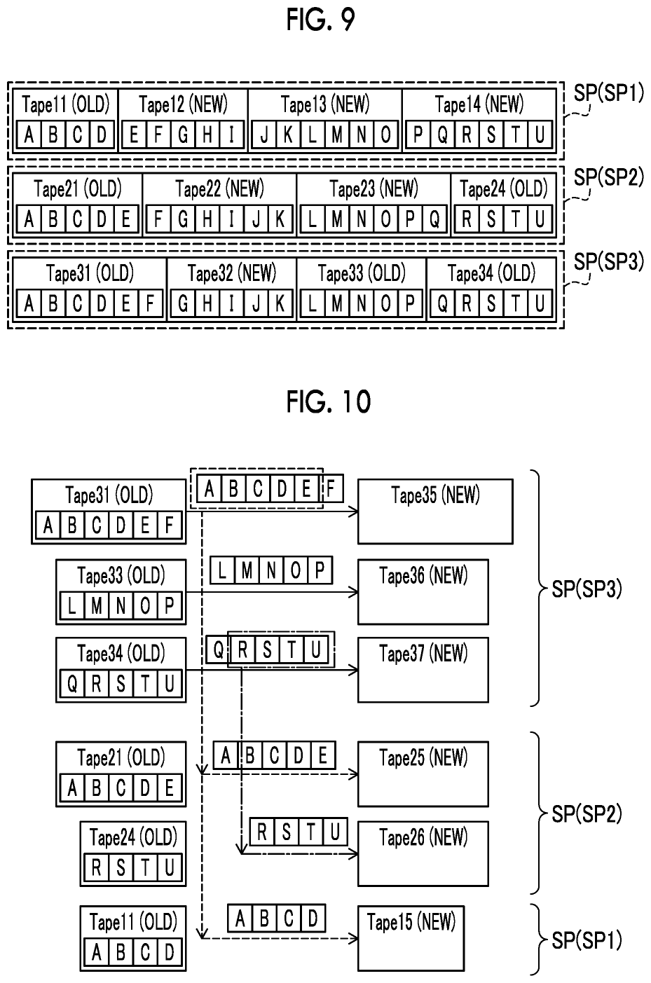

FIG. 9 illustrates an example of a data recording state in the magnetic tape T of each storage pool SP by the above control. In FIG. 9, one rectangle in which an alphabet is marked represents one piece of data. Further, in the example of FIG. 9, as the storage pool SP has a lower priority P, a ratio of the new-generation magnetic tapes T to all the magnetic tapes T included in the storage pool SP is lower. This is because a higher priority P is set for the storage pool SP on which reading and writing based on an access from the user are performed with higher priority.

As illustrated in FIG. 9, by the above control, pieces of data “A” to “D” recorded in the old-generation magnetic tape T of the storage pool SP1 are recorded in the old-generation magnetic tapes T of the storage pools SP2 and SP3 of which the priorities Ps are lower than the priority of the storage pool SP1. Similarly, pieces of data “A” to “E” and data “R” to “U” recorded in the old-generation magnetic tapes T of the storage pool SP2 are recorded in the old-generation magnetic tapes T of the storage pool SP3 of which the priority P is lower than the priority of the storage pool SP2.

Further, in a case where the reception unit 40 receives a data migration instruction, the controller 42 migrates data recorded in the old-generation magnetic tape T to the new-generation magnetic tape T in each of the plurality of storage pools SPs. For example, a magnetic tape T that is used for a certain period or longer, a magnetic tape T on which reading and writing are performed a certain number of times or more, a magnetic tape T of which an error rate in reading and writing is equal to or higher than a certain value, or the like is selected as a data-migration-source magnetic tape T. Further, for example, the magnetic tape T in which a ratio of pieces of data to be physically deleted (hereinafter, referred to as “data to be deleted”) is equal to or higher than a certain value or the magnetic tape T in which a total value of sizes of pieces of data to be deleted is equal to or larger than a certain value is selected as a data-migration-source magnetic tape T. Examples of data to be deleted include data of which a storage period is expired, data which is logically deleted, and the like.

When performing control of migrating data recorded in the old-generation magnetic tape T to the new-generation magnetic tape T, the controller 42 migrates the data in order from the storage pool SP of which the priority P is lowest. At this time, the controller 42 also uses data which is read from the old-generation magnetic tape T of the storage pool SP of which the priority P is relatively low, for data migration in the storage pool SP of which the priority P is relatively high. In data migration, in a case where data to be deleted is included in the data-migration-source magnetic tape T, the controller 42 may not migrate the data to be deleted. A specific example of data migration will be described with reference to FIG. 10. Here, a data recording state in the magnetic tape T of each storage pool SP is a state illustrated in FIG. 9, and a case where data recorded in the old-generation magnetic tape T of each storage pool SP is migrated to the new-generation magnetic tape T will be described as an example.

As illustrated in FIG. 10, first, the controller 42 performs control of reading data recorded in each old-generation magnetic tape T of the storage pool SP3 of which the priority P is lowest. Next, the controller 42 performs control of recording the data read by the control in the new-generation magnetic tape T of the storage pool SP3 as a data migration destination. These controls may be performed in series, or at least a part of the controls may be performed in parallel.

As described above, all pieces of data recorded in the old-generation magnetic tape T of the storage pool SP of which the priority P is relatively high are recorded in the old-generation magnetic tape T of the storage pool SP of which the priority P is lower than the priority of the storage pool SP. That is, as illustrated in FIG. 10, pieces of data recorded in the old-generation magnetic tapes Ts of the storage pools SP1 and SP2 are also recorded in the old-generation magnetic tapes T of the storage pool SP3.

Therefore, as illustrated by a broken-line arrow of FIG. 10, in a case where the controller 42 performs control of recording pieces of data “A” to “E” in the new-generation magnetic tape T of the storage pool SP2 as a migration destination, the controller 42 uses pieces of data “A” to “E” read from the old-generation magnetic tape T of the storage pool SP3. Similarly, in a case where the controller 42 performs control of recording pieces of data “R” to “U” in the new-generation magnetic tape T of the storage pool SP2 as a migration destination, the controller 42 uses pieces of data “R” to “U” read from the old-generation magnetic tape T of the storage pool SP3. Similarly, in a case where the controller 42 performs control of recording pieces of data “A” to “D” in the new-generation magnetic tape T of the storage pool SP1 as a migration destination, the controller 42 uses pieces of data “A” to “D” read from the old-generation magnetic tape T of the storage pool SP3. Thereby, processing of reading data from the old-generation magnetic tapes Ts of the storage pools SP1 and SP2 as data migration sources can be omitted. Thus, it is possible to shorten a time required for data migration.

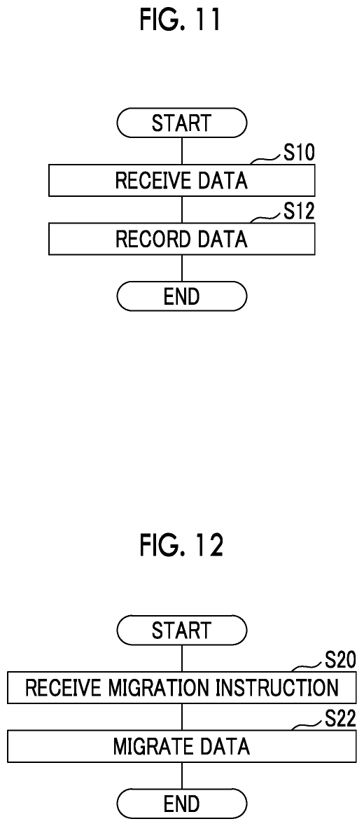

Next, an operation of the information processing apparatus 12 according to the present embodiment will be described with reference to FIG. 11 and FIG. 12. In a case where the CPU 20 executes the information processing program 30, data recording processing illustrated in FIG. 11 and data migration processing illustrated in FIG. 12 are executed. The data recording processing illustrated in FIG. 11 is executed, for example, in a case where the information processing apparatus 12 receives data to be recorded that is transmitted from the user terminal. Further, the data migration processing illustrated in FIG. 12 is executed, for example, in a case where the information processing apparatus 12 receives a data migration instruction.

In step S10 of FIG. 11, the reception unit 40 receives data to be recorded that is transmitted from the user terminal. In step S12, as described above, the controller 42 performs control of recording the data to be recorded that is received in step S10 in each of the three storage pools SPs. In the control, the controller 42 performs control of recording data, which is recorded in an old-generation magnetic tape T of the storage pool SP of which the priority P is relatively high, in an old-generation magnetic tape T of the storage pool SP of which the priority P is relatively low. In a case where the processing of step S12 is completed, data recording processing is completed.

In step S20 of FIG. 12, the reception unit 40 receives a data migration instruction. In step S22, as described above, the controller 42 migrates data recorded in the old-generation magnetic tape T to the new-generation magnetic tape T in each of the plurality of storage pools SPs. At this time, the controller 42 migrates the data in order from the storage pool SP of which the priority P is lowest. Further, at this time, the controller 42 also uses data which is read from the old-generation magnetic tape T of the storage pool SP of which the priority P is relatively low, for data migration in the storage pool SP of which the priority P is relatively high. In a case where the processing of step S22 is completed, data migration processing is completed.

The controller 42 may perform control of initializing the data-migration-source magnetic tape T of each storage pool SP after the data migration processing is completed. In this case, the initialized magnetic tape T can be reused. Further, the controller 42 may perform control of unloading the data-migration-source magnetic tape T of each storage pool SP from the tape library 14 after the data migration processing is completed. In this case, a new magnetic tape T can be included in the tape library 14 instead of the unloaded magnetic tape T.

As described above, according to the present embodiment, it is possible to shorten a time required for data migration.

In the above embodiment, a case where the priority P which is set for each storage pool SP is input by the user via the input device 24 has been described. On the other hand, the present disclosure is not limited thereto. For example, the information processing apparatus 12 may set the priority P to a higher degree as the number of the new-generation magnetic tapes T included in the storage pool SP increases. Further, for example, the information processing apparatus 12 may set the priority P to a higher degree as a total value of free capacities of the new-generation magnetic tapes T included in the storage pool SP is larger.

Further, in the above embodiment, the storage pool SP may include magnetic tapes Ts of three or more generations.

Further, in the embodiment, for example, as a hardware structure of a processing unit that executes various processing such as the reception unit 40 and the controller 42, the following various processors may be used. The various processors include, as described above, a CPU, which is a general-purpose processor that functions as various processing units by executing software (program), and a dedicated electric circuit, which is a processor having a circuit configuration specifically designed to execute a specific processing, such as a programmable logic device (PLD) or an application specific integrated circuit (ASIC) that is a processor of which the circuit configuration may be changed after manufacturing such as a field programmable gate array (FPGA).

One processing unit may be configured by one of these various processors, or may be configured by a combination of two or more processors of the same type or different types (for example, a combination of a plurality of FPGAs or a combination of a CPU and an FPGA). Further, the plurality of processing units may be configured by one processor.

As an example in which the plurality of processing units are configured by one processor, firstly, as represented by a computer such as a client and a server, a form in which one processor is configured by a combination of one or more CPUs and software and the processor functions as the plurality of processing units may be adopted. Secondly, as represented by a system on chip (SoC) or the like, a form in which a processor that realizes the function of the entire system including the plurality of processing units by one integrated circuit (IC) chip is used may be adopted. As described above, the various processing units are configured by using one or more various processors as a hardware structure.

Further, as the hardware structure of the various processors, more specifically, an electric circuit (circuitry) in which circuit elements such as semiconductor elements are combined may be used.

Further, in the embodiment, an example in which the information processing program 30 is stored (installed) in the storage unit 22 in advance has been described. On the other hand, the present disclosure is not limited thereto. The information processing program 30 may be provided by being recorded in a recording medium such as a compact disc read only memory (CD-ROM), a digital versatile disc read only memory (DVD-ROM), or a Universal Serial Bus (USB) memory. Further, the information processing program 30 may be downloaded from an external device via a network.

What is claimed is:

1. An information processing apparatus comprising:
at least one processor,
wherein the processor is configured to perform, in a case where the same data is recorded in each of a plurality of storage pools each of which includes a plurality of generations of magnetic tapes and each for which a priority representing a degree to which a relatively-new-generation magnetic tape is used with priority is set, control of recording data recorded in a relatively-old-generation magnetic tape of a storage pool of which the priority is relatively high, in a relatively-old-generation magnetic tape of a storage pool of which the priority is relatively low.

2. The information processing apparatus according to claim 1,
wherein the processor is configured to
perform, in a case of performing control of recording data in the storage pool in descending order of the priority and in a case where data is recorded in a relatively-new-generation magnetic tape of the storage pool of which the priority is relatively high, control of recording data in the storage pool of which the priority is relatively low without designating a magnetic tape as a data recording destination, and
perform, in a case where data is recorded in a relatively-old-generation magnetic tape of the storage pool of which the priority is relatively high, control of designating a relatively-old-generation magnetic tape of the storage pool of which the priority is relatively low and recording data in the designated relatively-old-generation magnetic tape of the storage pool of which the priority is relatively low.

3. The information processing apparatus according to claim 1,
wherein the priority is higher as the number of relatively-new-generation magnetic tapes included in the storage pool is larger or as a total value of free capacities of relatively-new-generation magnetic tapes included in the storage pool is larger.

4. The information processing apparatus according to claim 1,
wherein the processor is configured to migrate data in order from the storage pool of which the priority is relatively low in a case of migrating data recorded in a relatively-old-generation magnetic tape to a relatively-new-generation magnetic tape in each of the plurality of storage pools, and use data read from a relatively-old-generation magnetic tape of the storage pool of which the priority is relatively low, for data migration in the storage pool of which the priority is relatively high.

5. The information processing apparatus according to claim 2,
wherein the priority is higher as the number of relatively-new-generation magnetic tapes included in the storage pool is larger or as a total value of free capacities of relatively-new-generation magnetic tapes included in the storage pool is larger.

6. The information processing apparatus according to claim 2,
wherein the processor is configured to migrate data in order from the storage pool of which the priority is relatively low in a case of migrating data recorded in a relatively-old-generation magnetic tape to a relatively-new-generation magnetic tape in each of the plurality of storage pools, and use data read from a relatively-old-generation magnetic tape of the storage pool of which the priority is relatively low, for data migration in the storage pool of which the priority is relatively high.

7. The information processing apparatus according to claim 3,
wherein the processor is configured to migrate data in order from the storage pool of which the priority is relatively low in a case of migrating data recorded in a relatively-old-generation magnetic tape to a relatively-new-generation magnetic tape in each of the plurality of storage pools, and use data read from a relatively-old-generation magnetic tape of the storage pool of which the priority is relatively low, for data migration in the storage pool of which the priority is relatively high.

8. The information processing apparatus according to claim 5,
wherein the processor is configured to migrate data in order from the storage pool of which the priority is relatively low in a case of migrating data recorded in a relatively-old-generation magnetic tape to a relatively-new-generation magnetic tape in each of the plurality of storage pools, and use data read from a relatively-old-generation magnetic tape of the storage pool of which the priority is relatively low, for data migration in the storage pool of which the priority is relatively high.

9. An information processing method executed by a processor of an information processing apparatus, the method comprising:
performing, in a case where the same data is recorded in each of a plurality of storage pools each of which includes a plurality of generations of magnetic tapes and each for which a priority representing a degree to which a relatively-new-generation magnetic tape is used with priority is set, control of recording data recorded in a relatively-old-generation magnetic tape of a storage pool of which the priority is relatively high, in a relatively-old-generation magnetic tape of a storage pool of which the priority is relatively low.

10. The information processing method according to claim 9, the method further comprising:
performing, in a case of performing control of recording data in the storage pool in descending order of the priority and in a case where data is recorded in a relatively-new-generation magnetic tape of the storage pool of which the priority is relatively high, control of recording data in the storage pool of which the priority is relatively low without designating a magnetic tape as a data recording destination, and
performing, in a case where data is recorded in a relatively-old-generation magnetic tape of the storage pool of which the priority is relatively high, control of designating a relatively-old-generation magnetic tape of the storage pool of which the priority is relatively low and recording data in the designated relatively-old-generation magnetic tape of the storage pool of which the priority is relatively low.

11. The information processing method according to claim 9,
wherein the priority is higher as the number of relatively-new-generation magnetic tapes included in the storage pool is larger or as a total value of free capacities of relatively-new-generation magnetic tapes included in the storage pool is larger.

12. The information processing method according to claim 9, the method further comprising:
migrating data in order from the storage pool of which the priority is relatively low in a case of migrating data recorded in a relatively-old-generation magnetic tape to a relatively-new-generation magnetic tape in each of the plurality of storage pools, and using data read from a relatively-old-generation magnetic tape of the storage pool of which the priority is relatively low, for data migration in the storage pool of which the priority is relatively high.

13. The information processing method according to claim 10,
wherein the priority is higher as the number of relatively-new-generation magnetic tapes included in the storage pool is larger or as a total value of free capacities of relatively-new-generation magnetic tapes included in the storage pool is larger.

14. The information processing method according to claim 10, the method further comprising:
migrating data in order from the storage pool of which the priority is relatively low in a case of migrating data recorded in a relatively-old-generation magnetic tape to a relatively-new-generation magnetic tape in each of the plurality of storage pools, and using data read from a relatively-old-generation magnetic tape of the storage pool of which the priority is relatively low, for data migration in the storage pool of which the priority is relatively high.

15. A non-transitory computer-readable storage medium storing an information processing program for causing a processor of an information processing apparatus to execute a process comprising:
performing, in a case where the same data is recorded in each of a plurality of storage pools each of which includes a plurality of generations of magnetic tapes and each for which a priority representing a degree to which a relatively-new-generation magnetic tape is used with priority is set, control of recording data recorded in a relatively-old-generation magnetic tape of a storage pool of which the priority is relatively high, in a relatively-old-generation magnetic tape of a storage pool of which the priority is relatively low.

16. The non-transitory computer-readable storage medium storing the information processing program according to claim 15, the process further comprising:
performing, in a case of performing control of recording data in the storage pool in descending order of the priority and in a case where data is recorded in a relatively-new-generation magnetic tape of the storage pool of which the priority is relatively high, control of recording data in the storage pool of which the priority is relatively low without designating a magnetic tape as a data recording destination, and
performing, in a case where data is recorded in a relatively-old-generation magnetic tape of the storage pool of which the priority is relatively high, control of designating a relatively-old-generation magnetic tape of the storage pool of which the priority is relatively low and recording data in the designated relatively-old-generation magnetic tape of the storage pool of which the priority is relatively low.

17. The non-transitory computer-readable storage medium storing the information processing program according to claim 15,
wherein the priority is higher as the number of relatively-new-generation magnetic tapes included in the storage pool is larger or as a total value of free capacities of relatively-new-generation magnetic tapes included in the storage pool is larger.

18. The non-transitory computer-readable storage medium storing the information processing program according to claim 15, the process further comprising:
migrating data in order from the storage pool of which the priority is relatively low in a case of migrating data recorded in a relatively-old-generation magnetic tape to a relatively-new-generation magnetic tape in each of the plurality of storage pools, and using data read from a relatively-old-generation magnetic tape of the storage pool of which the priority is relatively low, for data migration in the storage pool of which the priority is relatively high.

19. The non-transitory computer-readable storage medium storing the information processing program according to claim 16,
wherein the priority is higher as the number of relatively-new-generation magnetic tapes included in the storage pool is larger or as a total value of free capacities of relatively-new-generation magnetic tapes included in the storage pool is larger.

20. The non-transitory computer-readable storage medium storing the information processing program according to claim 16, the process further comprising:
migrating data in order from the storage pool of which the priority is relatively low in a case of migrating data recorded in a relatively-old-generation magnetic tape to a relatively-new-generation magnetic tape in each of the plurality of storage pools, and using data read from a relatively-old-generation magnetic tape of the storage pool of which the priority is relatively low, for data migration in the storage pool of which the priority is relatively high.
